(19) United States
(12) Patent Application Publication
(10) Pub. No.: US 2004/0004843 A1
(43) Pub. Date: Jan. 8, 2004

(54) System and method for providing polychromatic illumination of selected frequencies

(76) Inventors: Volker Melzer, Munich (DE); Tobias Damm, Munchen (DE); Peter Mueller, Mering (DE); Ralph Thoma, Augsburg (DE)

Correspondence Address: Agfa Corporation, Law & Patent Department, 200 Ballardvale Street, Wilmington, MA, 01887-1069, US

(21) Appl. No.: 10/218,734

(22) Filed: Aug. 14, 2002

Related U.S. Application Data
(60) Provisional application No. 60/394,129, filed on Jul. 3, 2002.

(51) Int. Cl. F21V 11/00

(52) U.S. Cl. 362/510

(57) ABSTRACT

An illumination system is disclosed for producing polychromatic illumination. The illumination system includes a plurality of monochromatic illumination sources for producing a plurality of monochromatic illumination fields, and a modulator for receiving each of the plurality of monochromatic illumination fields and for producing a polychromatic illumination field along an output direction that includes at least a portion of each of the monochromatic illumination fields. In accordance with an embodiment, the system uses time division multiplexing for color mixing.

This Application claims priority to U.S. Provisional Application Ser. No. 60/394,129 filed Jul. 3, 2002.

### BACKGROUND OF THE INVENTION

The invention generally relates to illumination systems, and relates in particular to systems for producing polychromatic illumination of selected frequencies.

Illumination sources that provide polychromatic illumination of selected frequencies may be used for a wide variety of purposes, including for example, imaging and communication.

For example, U.S. Pat. No. 6,219,015 discloses an imaging system and method for providing a visual display by combining grating light valves (GLVs) and exploiting the grating dispersion of white light to isolate the three primary color components of each pixel in a color display system. This patent also discloses the use of separate monochromatic light sources.

U.S. Pat. No. 6,342,960 discloses a communication system that divides a broadband wavefront into a plurality of signals of different frequencies using a diffraction grating and a plurality of GLVs for separately modulating each different signal.

Although white light or broadband sources include illumination of a wide range of frequencies, these sources in either of the above systems may require that the light that is outside the selected frequencies be filtered to avoid noise or high intensity background light.

There is a need, therefore, for an efficient and economical system and method for producing polychromatic illumination of selected frequencies.

### SUMMARY OF THE INVENTION

The invention provides an illumination system for producing polychromatic illumination. The illumination system includes a plurality of monochromatic illumination sources for producing a plurality of monochromatic illumination fields, and a modulator for receiving each of the plurality of monochromatic illumination fields and for producing a polychromatic illumination field along an output direction that includes at least a portion of each of the monochromatic illumination fields. In an embodiment, the illumination system includes three monochromatic illumination fields and the modulator produces a polychromatic illumination field that is time division multiplexed.

### BRIEF DESCRIPTION OF THE DRAWINGS

The following description may be further understood with reference to the accompanying drawings in which:

FIG. 1 shows an illustrative diagrammatic view of an illumination system in accordance with an embodiment of the invention;

FIGS. 2A and 2B show illustrative diagrammatic views of the ribbons of a gradient light valve modulator having a spacing of Δ₁ in accordance with an embodiment of the invention;

FIGS. 3A and 3B show illustrative graphical views of the intensity distribution in the Fourier plane for a non-activated grating and an activated grating;

FIGS. 4A and 4B show illustrative diagrammatic views of the ribbons of a gradient light valve modulator having a spacing of Δ₂ in accordance with an embodiment of the invention;

FIGS. 5A and 5B show illustrative diagrammatic views of the ribbons of a gradient light valve modulator having a spacing of Δ₃ in accordance with an embodiment of the invention;

FIG. 6 shows an illustrative diagrammatic view of a timing chart for an illumination system in accordance with an embodiment of the invention;

FIG. 7 shows an illustrative diagrammatic view of an imaging system incorporating a polychromatic illumination system in accordance with an embodiment of the invention;

FIG. 8 shows an illustrative diagrammatic view of a communication system incorporating a polychromatic illumination system in accordance with an embodiment of the invention; and

FIG. 9 shows an illustrative diagrammatic view of a timing chart for an communication system in accordance with an embodiment of the invention.

The drawings are shown for illustrative purposes only.

### DETAILED DESCRIPTION OF THE INVENTION

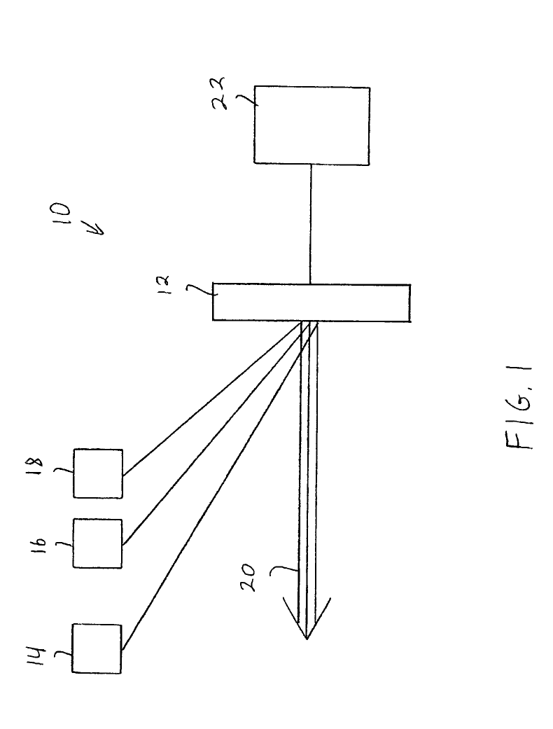

As shown in FIG. 1, an illumination system 10 in accordance with an embodiment of the invention includes a light modulator 12, which may, for example be a GLV. The GLV 12 receives monochromatic illumination signals from each of three monochromatic sources 14, 16 and 18 and produces a polychromatic illumination field 20. The monochromatic sources 14, 16 and 18 produce illumination having wavelengths of λ₁, λ₂ and λ₃ respectively. The diffraction relationship between the grating period and the diffraction angle is defined by:

$$sin {α}_{MAX} = k \frac{λ}{Δ}$$

where kεN, α_{MAX} is the diffraction angle, λ is the wavelength of the carrier signal, and Δ is the grating period. In an embodiment, the angle of incidence of each monochromatic illumination field onto the GLV 12 is determined such that the polychromatic illumination is directed in the same direction (shown perpendicular to the GLV 12 in FIG. 1) without adjusting the modulator. The polychromatic illumination is produced by the (e.g., first order) reflection of the monochromatic illumination off of the GLV 12. In this embodiment, the intensity of each of the monochromatic illumination fields within the combined polychromatic illumination is determined by the intensity of each of the monochromatic sources 14, 16 and 18.

In another embodiment, the intensity of each monochromatic illumination field within the polychromatic illumination may be varied with respect to one another. In this embodiment, the angles of incidence of each monochromatic illumination beam on the GLV 12 is selected such that the first order reflected signals are coincident upon one another for grating period spacing that are readily achievable by the GLV 12, e.g., Δ₁, Δ₂ and Δ₃ where Δ₂=2Δ₁ and Δ₃=3Δ₁. The operation of the system may be characterized by the following relationship:

$${θ}_{rad} = \frac{{λ}_{j}}{2 {Δ}_{j}}$$

where θ_{rad} is the angle of incidence of each monochromatic field onto the GLV 12, λⱼ is the wavelength of the carrier signal at each frequency and Δ₁ is the grating period for each wavelength λⱼ. In particular, the GLV 12 may provide a grating period of Δ₁ and be switchable as shown at 26 and 28 in FIGS. 2A and 2B to provide the responses 30 and 32 shown in FIGS. 3A and 3B respectively. Specifically, when the grating appears as shown at 26 in FIG. 2A the response to a carrier signal λ₁ may be as shown at 30 in FIG. 3A including virtually no response in the first order, whereas when the grating appears as shown at 28 in FIG. 2B the response may be as shown at 32 in FIG. 3B including a strong first order response. The intensity of the first order response may be adjusted between the levels shown in FIGS. 3A and 3B by adjusting the GLV to a position intermediate the positions shown in FIGS. 2A and 2B.

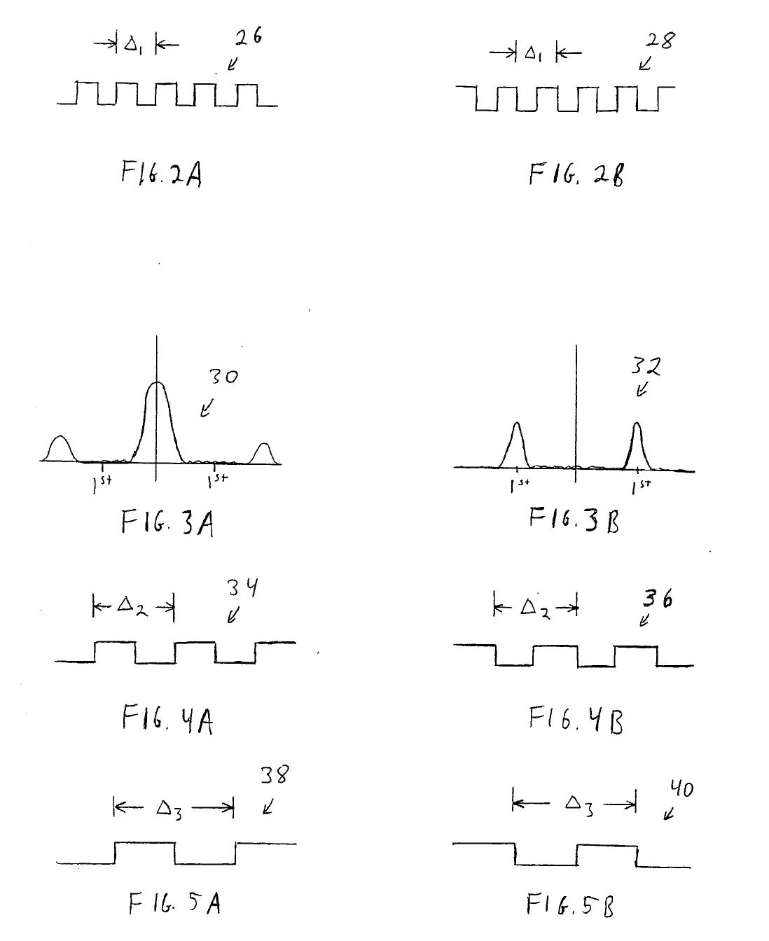

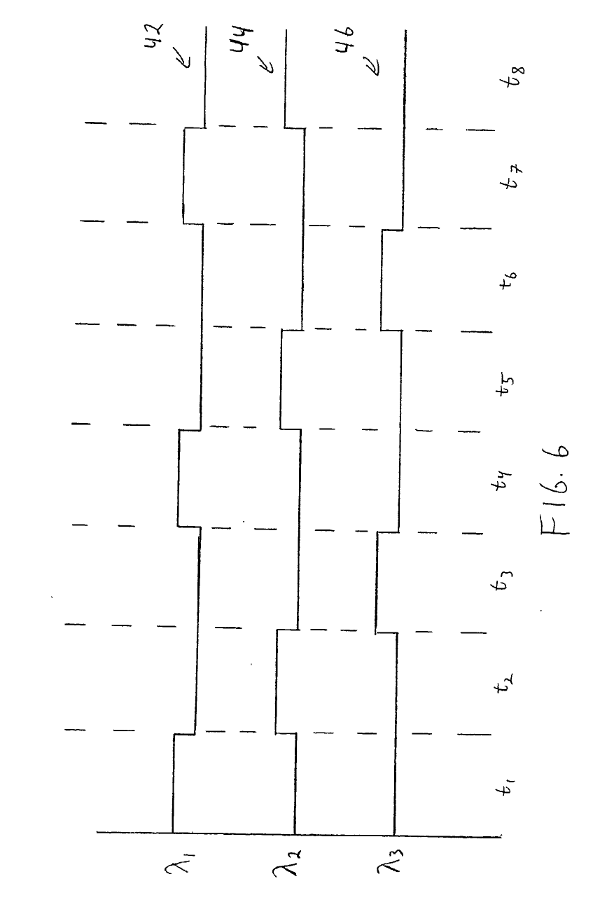

As shown at 34 and 36 in FIGS. 4A and 4B, the grating period may be changed to be A₂ 2 Δ₁ by pairing adjacent ribbons. If the values of θ_{rad}, λⱼ and Δⱼ are properly chosen, the first order response angle for the signal λ₂ using a grating period of Δ₂ will be the same as for λ₁ using the grating period Δ₁ (of, for example, 3-5 microns). Similarly, the grating period maybe changed to be Δ₃=3 Δ₁ as shown at 38 and 40 in FIGS. 4A and 4B, and with properly chosen values for θ_{rad}, λ₁ and Δⱼ the first order response angle for the carrier signal λ₃ using a grating period of Δ₃ will be the same as for λ₁ using the grating period of Δ₁.

These first order signals may be time division multiplexed by timing the modulator (coupled to a controller 22) to provide the grating period Δ₁ at times t₁, t₄, t₇ etc., to provide the grating period Δ₂ at times t₂, t₅, t₈ etc., and to provide the grating period Δ₃ at times t₃, t₆ etc. In particular, as shown at 42 in FIG. 6, the first order reflected λ₁ signal includes a high intensity during times t₁, t₄, t₇ etc. As shown at 44 in FIG. 6, the first order reflected λ₂ signal includes a high intensity during times t₂, t₅, t₈ etc. As shown at 46 in FIG. 6, the first order reflected λ₃ signal includes a high intensity during times t₃, t₆ etc. The system, therefore, permits multiple monochromatic signal to be selectively combined at high speeds using the above relationship between θ_{rad}, λⱼ and αⱼ.

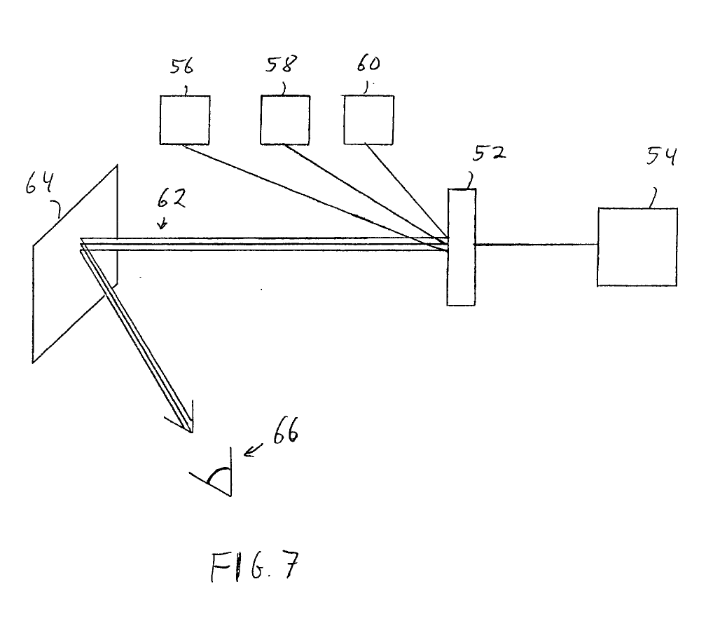

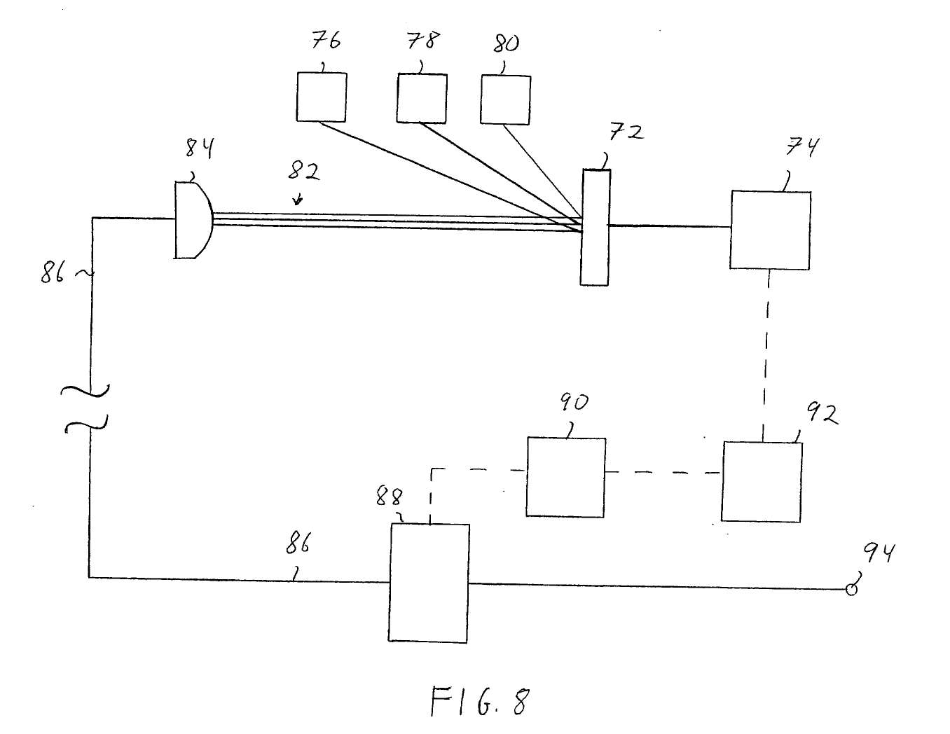

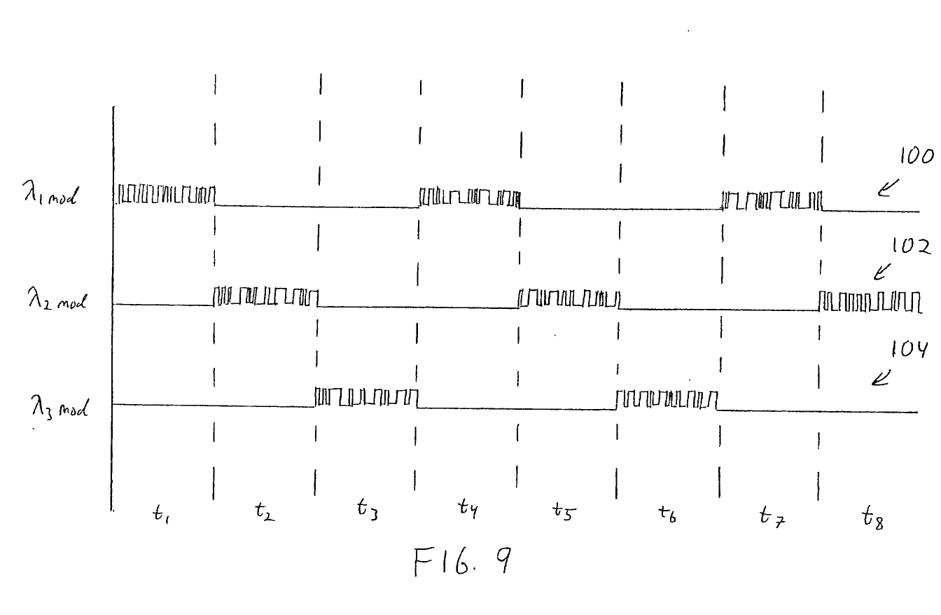

As shown in FIG. 7, an illumination system of the invention may be used with an imaging system for viewing a diffractive image such as a hologram. In particular the system may include a modulator 52 such as a GLV, three monochromatic light sources 56, 58 and 60 and a modulation controller 54. The illumination system produces a time division multiplexed polychromatic illumination 62 that is directed toward a previously recorded holographic recording 64. Preferably, the holographic recording has been recorded using monochromatic coherent light sources that are the same frequencies as the three monochromatic sources 56, 58 and 60. The resulting image may then be view as indicated at 66. Such an illumination system may also be used for viewing systems in which it is desirable to selectively view or exclude one or more of the recorded images by selectively including or excluding one of the light sources. In other embodiments, the system may be used for holographic memory.

As shown in FIG. 8, an illumination system in accordance with an embodiment of the invention may be used in connection with a communication system for transmitting digital data via optical fibers. The illumination system may include a modulator 72 such as a GLV, three monochromatic light sources 76, 78 and 80 that provide carrier signals, and a transmitter controller 74. The illumination system produces time division multiplexed modulated signals by switching the modulator on and off during the on period for each monochromatic source shown in FIG. 6. In particular, as shown in FIG. 9, illumination from the first source 76 is modulated during time intervals t₁, t₄, t₇ etc. as shown at 100, illumination from the second source 78 is modulated during time intervals t₂, t₅, t₈ etc. as shown at 102, and illumination from the third source 80 is modulated during time intervals t₃, t₆ etc. as shown at 104.

The time divisional multiplexed modulated signals 82 are direct via optics 84 into an optical fiber 86 for transmission to a receiver that includes a detector 88, a receiver controller 90 and an output 94. The receiver controller 90 and the transmitter controller 74 are commonly coupled to a timing controller 92.

In further embodiments, each of the values θ_{rad},λ and Δ maybe variable to achieve further systems of increased flexibility and functionality. Those skilled in the art will appreciate that numerous modifications and variations may be made to the above disclosed embodiments without departing from the spirit and scope of the present invention.

What is claimed is:

1. An illumination system for producing polychromatic illumination, said illumination system comprising:
a plurality of monochromatic illumination sources for producing a plurality of monochromatic illumination fields; and
a modulator for receiving each of said plurality of monochromatic illumination fields and for producing a polychromatic illumination field along an output direction that includes at least a portion of each of said monochromatic illumination fields.

2. An illumination system as claimed in claim 1, wherein said monochromatic illumination fields are time division multiplexed in said polychromatic illumination field.

3. An illumination system as claimed in claim 1, wherein said illumination system includes three monochromatic illumination sources.

4. An illumination system as claimed in claim 1, wherein said modulator modulates said monochromatic illumination fields by diffraction of light.

5. An illumination system as claimed in claim 1, wherein said modulator is a grating light valve.

6. An illumination system as claimed in claim 1, wherein said modulator is adjustable to select one of said monochromatic illumination fields at a time for inclusion in said polychromatic illumination field.

7. An illumination system as claimed in claim 1, wherein said illumination system is used to view a diffraction recording.

8. An illumination system as claimed in claim 7, wherein said diffraction recording is a holographic recording.

9. An illumination system as claimed in claim 1, wherein said illumination system is coupled to a communication system.

10. An illumination system for producing polychromatic illumination, said illumination system comprising:
a first monochromatic illumination source for producing a first monochromatic illumination field;
a second monochromatic illumination source for producing a second monochromatic illumination field; and
a grating light valve that provides a first grating period in a first arrangement, and provides a second grating period in a second arrangement, said grating light valve providing a first order reflected signal of said first monochromatic illumination field when said grating light valve is in said first arrangement along an output direction, and providing a first order reflected signal of said second monochromatic illumination field when said grating light valve is in said second arrangement along said output direction.

11. An illumination system as claimed in claim 10, wherein said monochromatic illumination fields within said polychromatic illumination are time division multiplexed.

12. An illumination system as claimed in claim 10, wherein said illumination system further includes a third monochromatic illumination source for producing a third monochromatic illumination field and said grating light valve provides a first order reflected signal of said third monochromatic illumination field along said output direction when said grating light valve is in a third arrangement having a third grating period.

13. An illumination system as claimed in claim 10, wherein said illumination system is used with an imaging system.

14. An illumination system as claimed in claim 10, wherein said illumination system is coupled to a communication system.

15. An illumination system for providing polychromatic illumination, said system comprising:
a modulator for selectively providing illumination from one of a plurality of monochromatic illumination fields along an output direction, said modulator including gratings having a period that may be selectively varied.

16. An illumination system as claimed in claim 15, wherein said monochromatic illumination fields are time division multiplexed along said output direction.

17. An illumination system as claimed in claim 15, wherein said illumination system is used to view a diffraction recording.

18. An illumination system as claimed in claim 17, wherein said diffraction recording is a holographic recording.

19. An illumination system as claimed in claim 15, wherein said illumination system is coupled to a communication system.
